(19) United States
(12) Patent Application Publication
(10) Pub. No.: US 2002/0152242 A1
(43) Pub. Date: Oct. 17, 2002

(54) System for monitoring the usage of intranet portal modules

(76) Inventors: Kristin S. Meyer, Cincinnati, OH (US); Lance C. Shumaker, Loveland, OH (US); David M. Darpel, Crescent Springs, KY (US); Jamie T. Livingston, Cincinnati, OH (US)

Correspondence Address: MCNEES WALLACE & NURICK LLC, 100 PINE STREET, P.O. BOX 1166, HARRISBURG, PA, 17108-5300, US

(21) Appl. No.: 09/833,431

(22) Filed: Apr. 12, 2001

(51) Int. Cl. G06F 15/00

(52) U.S. Cl. 707/526

(57) ABSTRACT

A module-based Intranet portal is monitored to determine the usage of the modules of the Intranet portal. Detailed information relating to the usage of a module by a user is recorded and stored in a database. A user can then retrieve the detailed information on module usage from the database. The retrieved information is displayed in a chart or table for the user and includes information on the number of users of the module, the number of hits for the module, the number of times the module has been added to a user's portal and the number of times the module has been removed from the user's portal. In addition, the retrieved information can be sorted or arranged in the chart based on a number of different criteria. The different criteria for sorting the retrieved information includes the community of the user, the browser of the user, the country of the user, the index page of the user, the location of the user, the manager of the user and the operating system of the user.

### BACKGROUND OF THE INVENTION

The present invention relates generally to monitoring Intranet usage. More specifically, the present invention relates to monitoring the usage of modules that are used to construct an Intranet portal.

Many corporations and organization have Intranets that are used by their employees to access information and utilities that can assist the employees in performing their duties. These Intranets typically include web pages having a common design or layout (“look and feel”). The web pages can be written in HTML and Java and viewed using a web browser. Large-scale Intranets may include over 500,000 static web pages of information, which are available for access by employees. The employees, using the Intranet, may also be able to access the Internet for additional information. Employees of a corporation or organization may also have to execute a desktop application to access certain types of resources or information available on the corporation's network because the information or resource is not available or accessible from the Intranet.

To assist employees in navigating and accessing the large amounts of information and resources available on the Intranet, an organization may provide the employees with an Intranet portal. One type of Intranet portal that can be provided is a module-based Intranet portal that uses modules to provide the employee or user with access to the different types of information and resources. The modules are frequently written in Java Servlet Pages so that the Intranet portal can provide access to information and resources that are not located on the Intranet. To maintain the Intranet portal as a viable tool, the Intranet portal has to be frequently updated by adding, removing and revising modules to keep pace with the ever-changing needs of the users. To assist with the maintenance of the Intranet portal, a portal management team may want to measure or monitor the usage of the modules to determine if the modules are successful and should be kept in the portal or unsuccessful and removed from the portal. In addition, the portal management team may be able to determine the. modules that need to be revised based on module usage information.

There are a number of software packages available that can measure the usage of web pages that are written in HTML or Java. Typically, the user has to target a specific URL or sequence of URLs to determine the number of users visiting that site or portion of the site. The data returned by these software packages often does not include specific types of information that is valuable to the portal management team or is not displayable in a particular format. In addition, these software packages cannot monitor the usage of modules because the modules are typically written in JSP, which is not compatible or understandable by the software packages.

Therefore, what is needed is an application that can monitor and collect information on the usage of modules in an Intranet portal and provide a user with the usage information that is easy to understand and format.

### BRIEF SUMMARY OF THE INVENTION

The present invention is directed to a system for tracking and displaying module usage in a portal for a computer network. The system includes a server computer having a processor and a memory device and a client computer having a memory device. The client computer is connected to the server computer through the computer network. The system also includes a portal stored in the memory device of the server computer and accessible by a user on a client computer. The portal includes a plurality of modules. The system also includes means for monitoring usage by a user on a client computer of each module of the plurality of modules and means for generating usage information from the monitored usage. A database stored in the memory device of the server computer is used to store the generated usage information of each module. The system has means for retrieving usage information from the database on a request from a user and means for displaying the retrieved usage information to a user on a client computer.

Another embodiment of the present invention is directed to a computer program product embodied on a computer readable medium and executable by a computer for tracking and displaying usage of components of a computer network portal customizable by each user. The computer program product includes means for monitoring selection of a component of a computer network portal by a user and means for collecting information on a user selecting a component of the computer network portal. A database is used to store the collected information for each component of the computer network portal. The computer program product also includes means for retrieving information for a particular component from the database on a request from a user and means for displaying the retrieved information to the user.

One advantage of the present invention is that it provides several pieces of data useful in measuring the success of a module for an Intranet portal.

Another advantage of the present invention is that it provides information on relevant modules and on modules that are arranged in a user-friendly manner to be easy to use.

Still another advantage of the present invention is that it can be used to help set Intranet portal strategy and priorities for the development of new modules by providing detailed information on usage of existing modules.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

The present invention is described in greater detail below with reference to the following drawing:

FIG. 1 illustrates a module usage statistics window of the present invention.

Whenever possible, the same reference numbers will be used throughout the figures to refer to the same parts.

### DETAILED DESCRIPTION OF THE INVENTION

The present invention is directed to an application for a computer network that is used to monitor the usage of items on the computer network and then display the usage data or information to a user. The computer network is preferably an Intranet, however the application can also be used with any other type of network, for example, the Internet, a local area network (LAN), a wide area network (WAN) or Extranet. The computer network preferably has a central or server computer that is used to store the application. The computer network also preferably has one or more remote or client computers that can access the application stored on the server computer. The client computers and server computer can be any type of general purpose computer having memory devices (e.g. RAM, ROM, hard disk, CD-ROM, etc.), processing units (e.g. CPU, ALU, etc.) and input/output devices (e.g. monitor, keyboard, mouse, printer, etc.).

In another embodiment of the present invention, each of the client or remote computers are again linked together through an Intranet, however instead of accessing the application on the server computer, the client computers have loaded into their memory a complete copy of the application. The application is preferably a software application that is executed from the memory device of the client computer. The application can be loaded into the memory device of the client computer from a portable medium such as a CD-ROM, DVD-ROM, floppy disk, etc., that is inserted into the client computer. Alternatively, the application can be transferred or loaded directly into the memory device of the client computer through an electronic connection with another computer that has a stored copy of the application. In other words, the application can be downloaded to a client computer from another computer over the network. Finally, the application may be implemented as hardware and incorporated as part of either client computers or the server computer.

As discussed above, the computer network is preferably an Intranet. To access data, applications, information and processes on the Intranet, the users of the Intranet can be provided with an Intranet portal. The Intranet portal operates to assist users in navigating and using the Intranet to access the data, applications, information and processes on the Intranet. In a preferred embodiment of the present invention, the Intranet portal is constructed from modules or components. The modules are small pieces of functionality or applications preferably implemented with Java Server Page (JSP) or Servlet application programming interface (API) technology to supply or provide access to data, applications, information and processes to the user over the Intranet regardless of where the data, applications, information and processes are located relative to the Intranet.

To provide the user with access to the data, applications, information and processes in the Intranet portal, the modules are preferably arranged as windows or web pages in the Intranet portal. Preferably the modules are arranged as a plurality of windows in the Intranet portal with each module being embodied in a single window. However, it is to be understood that the modules can be included as web pages in frames of the Intranet portal or any other similar manner. When a user is interested in accessing the usage statistics of a particular module, the user has to first access or display the module and then select a command that displays the usage statistics for that module. In a preferred embodiment of the present invention, the command for usage statistics is a button with an “S” located in the upper right-hand corner of the window of the module. However, the command for displaying usage statistics can be a link located in the window or web page or a menu option or any other similar way for presenting a command or option for selection by a user.

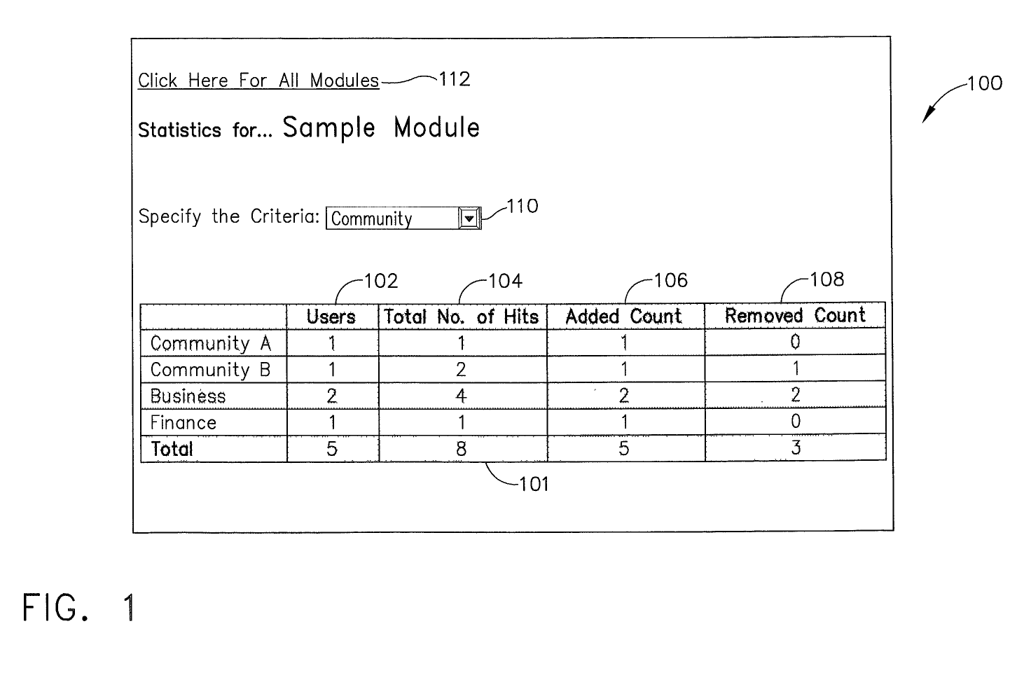

After the user has selected the command for the usage statistics, a new window is opened with the usage statistics for the module or the user is linked to a web page with the usage statistics. FIG. 1 illustrates a window 100 with the usage statistics for the module selected by the user. In the usage statistics window 100, information from several different categories relating to module usage is displayed to the user in a chart or table 101. The usage information displayed to the user in chart 101 includes user information 102, which represents the number of unique users of the module from a pre-determined date, total hits information 104, which represents the number of times the module has been used from a predetermined date, added count information 106, which represents the number of times the module has been added to a user portal from a predetermined date, and removed count information 108, which represents the number of times the module has been removed from a portal by a user from a predetermined date.

The usage information 102-108 in the usage statistics window 100 can be sorted, filtered or “broken down” on different criteria or elements to provide the user with different views of the usage information 102-108 in chart 101. The user can use a criteria selection field 110 for the selection of the sorting criteria. In a preferred embodiment of the present invention, the criteria selection field 110 uses a pull-down menu to permit the user to select the criteria for sorting. However, it is to be understood that other techniques for selecting the criteria for sorting can also be used. Once the user has selected the sorting criteria, the usage information 102-108 is sorted and displayed to the user in chart 101 based on that criterion. For example, in FIG. 1, “community” has been selected in criteria selection field 110. The selection of community results in the usage information 102-108 being sorted according to the different communities that use the Intranet portal. In a similar fashion, the selection of a different criterion in criteria selection field 110 results in a sorting of the usage information 102-108 into the different categories of that particular criterion. Referring back to FIG. 1, the selection of community results in the display of usage information 102-108 in chart 101 for four different communities. In addition, the individual usage information 102-108 for each of the categories is totaled or summed to provide total usage statistics for each type of usage information 102-108.

There can be several different criteria that can be selected by the user in criteria selection field 110 for the sorting of usage information 102-108. For example, the user can select a community criterion, which sorts or organizes the usage information 102-108 based on the group, division or department of the user. The selection of the browser criterion sorts the usage information based on the Internet browser of the user. The selection of the country criterion sorts or arranges the usage information based on the country of the user. The selection of the index page criterion sorts the usage information based on the page or section within the Intranet portal where the user has placed the module. The selection of the location criterion sorts on the location (city and state) or site of the user. The selection of the manager criterion sorts the usage information 102-108 based on the user's manager. The selection of the operating system criterion sorts the usage information 102-108 based on the operating system being used by the user.

In another embodiment of the present invention, after the user has selected the criterion for sorting in the criteria selection field 110, the user can select a command 112 that displays usage information 102-108 sorted by the selected criterion for all the modules available on the Intranet portal. In other words, the all modules command or option 112 displays to the user all the information about every module currently existing in the Intranet portal. The display of the usage information 102-108 for all of the modules can be as a series of charts 101, with a chart per module, that can be accessed sequentially or by jumping to a particular chart 101. The display of the usage information 102-108 for all of the modules can also be as a single chart with the criterion categories identified for each module. The display of the usage information 102-108 for all of the modules can further be in a tabular form to permit the user to display the usage information 102-108 using tabs. The display of the usage information 102-108 can also include a sum or total of the individual usage information 102-108 for each of the categories to provide total usage statistics for each type of usage information 102-108.

To provide this usage information 102-108 for each of the sorting criteria, the application collects data from the user's profile each time a module is accessed, added, deleted or moved by a user. In addition, the application can also detect additional data or information relating to the user each time a module is accessed, added, deleted or moved by the user. The user profile typically has information about the user such as the user's location, community, manager, etc. The collected and detected information is then stored and indexed in a database for recall when requested by a user. The database is queried for the appropriate information based on the request of the user and then is displayed to the user in chart 101. The application of the present invention is preferably implemented with Java Server Page (JSP) or Servlet application programming interface (API) technology for use in the preferred Intranet portal. The writing of the application in JSP permits the application to be able to monitor usage of the modules that are written in JSP. However, it is to be understood that the application of the present invention can be written in any language that can work with JSP modules to monitor the usage of the JSP modules.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for tracking and displaying module usage in a portal for a computer network, the system comprising:
a server computer having a memory device;
a client computer being connected to the server computer;
a portal stored in the memory device of the server computer and accessible by a user from a client computer, the portal comprising a plurality of modules;
means for monitoring selection of a module of the plurality of modules by a user on a client computer;
means for collecting information on a user selecting a module of the plurality of modules;
a database stored in the memory device of the server computer, the database storing the collected information for each module of the plurality of modules;
means for retrieving information for a particular module from the database on a request from a user; and
means for displaying the retrieved information to a user on a client computer.

2. The system of claim 1 wherein the means for retrieving information for a particular module comprises means for sorting the stored information for the particular module based on a criterion designated by a user.

3. The system of claim 2 wherein the criterion is one of a community of a user, a browser of a user, a country of a user, an index page of a user, a location of a user, a manager of a user and an operating system of a user.

4. The system of claim 1 wherein:
the portal is customizable by each user to include modules selected by a user; and
the means for monitoring selection of a module further comprises:
means for detecting accessing of a module by a user;
means for detecting addition of a module to the portal by a user;
means for detecting removal of a module from the portal by a user; and
means for detecting movement of a module in the portal by a user.

5. The system of claim 4 wherein the retrieved information includes at least one of a number of unique users of the particular module, a number of accesses of the particular module, a number of users adding the particular module to the portal and a number of users removing the particular module from the portal.

6. The system of claim 1 wherein the means for retrieving information for a particular module comprises means for selecting an appropriate command in the particular module.

7. The system of claim 1 wherein the means for collecting information on a user includes means for extracting data from a user profile of a user.

8. The system of claim 1 further comprising means for retrieving information from the database for all modules of the plurality of modules.

9. The system of claim 1 wherein each module of the plurality of modules is written in Java Server Pages.

10. The system of claim 1 wherein the server computer and the client computer are connected by an Intranet.

11. A computer program product embodied on a computer readable medium and executable by a computer for tracking and displaying usage of components of a computer network portal customizable by each user, the computer program product comprising:
means for monitoring selection of a component of a computer network portal by a user;
means for collecting information on a user selecting a component of the computer network portal;
a database to store the collected information for each component of the computer network portal;
means for retrieving information for a particular component from the database on a request from a user; and
means for displaying the retrieved information to a user.

12. The computer program product of claim 11 wherein the means for retrieving information for a particular component comprises means for sorting the stored information for the particular component based on a criterion selected by a user.

13. The computer program product of claim 12 wherein the criterion is one of a community of a user, a browser of a user, a country of a user, an index page of a user, a location of a user, a manager of a user and an operating system of a user.

14. The computer program product of claim 11 wherein the means for monitoring selection of a component further comprises:
means for detecting accessing of a component by a user;
means for detecting addition of a component to the computer network portal by a user;
means for detecting removal of a component from the computer network portal by a user; and
means for detecting movement of a component in the computer network portal by a user.

15. The computer program product of claim 14 wherein the retrieved information includes at least one of a number of unique users of the particular component, a number of accesses of the particular component, a number of users adding the particular component to the computer network portal and a number of users removing the particular component from the computer network portal.

16. The computer program product of claim 11 wherein the means for collecting information on a user includes means for detecting data relating to a user each time a user selects a component of the computer network portal.

17. The computer program product of claim 11 wherein each component of the computer network portal is written in Java Server Pages.

18. The computer program product of claim 11 wherein the computer network portal is an Intranet portal.

19. The computer program product of claim 9 wherein the means for retrieving information for a particular component comprises means for selecting an appropriate command in the particular component.

20. A method for tracking and displaying module usage in a portal for a computer network, the method comprising the steps of:
providing a portal having a plurality of modules, wherein the portal being customizable by each user of the portal;
monitoring selection of a module of the plurality of modules by a user;
extracting data from a user profile of a user of the selected module of the plurality of modules;
collecting information on a user selecting a module of the plurality of modules;
storing the collected information for each module of the plurality of modules in a database;
retrieving information on a particular module from the database based on a criterion designated by a user, wherein the criterion is one of a community, a browser, a country, an index page, a location, a manager and an operating system; and
displaying the retrieved information to a user on a computer, wherein the retrieved information includes at least one of a number of unique users of the particular module, a number of accesses of the particular module, a number of users adding the particular module to the portal and a number of users removing the particular module from the portal.
